(19) United States
(12) Patent Application Publication
(10) Pub. No.: US 2010/0139713 A1
(43) Pub. Date: Jun. 10, 2010

(54) Dipper Well System

(76) Inventors: David J. Averbeck, Dousman, WI (US); Rebecca M. Tallon, Hartland, WI (US); Michael Saveliev, Huntington Beach, CA (US); John W. Shanahan, White Bear Lake, MN (US); Robert O. Crowder, Lino Lakes, MN (US); John H. Burban, Lake Elmo, MN (US); Steven T. Jersey, Laguna Niguel, CA (US); Philip M. Rolchigo, Eden Prairie, MN (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/608,896

(22) Filed: Oct. 29, 2009

Related U.S. Application Data
(60) Provisional application No. 61/109,865, filed on Oct. 30, 2008.

(51) Int. Cl. B08B 3/04

(52) U.S. Cl. 134/103.1

(57) ABSTRACT

Embodiments of the invention provide a dipper well to clean smallwares, such as spoons, measuring cups, and ice-cream scoops. The dipper well can include a basin and a recirculation system. The recirculation system can draw a fluid from the basin. The recirculation system can include a filter to reduce contaminants in the fluid before the fluid is recycled back into the basin.

### RELATED APPLICATIONS

This application claims priority under 35 U.S.C. §119 to U.S. Provisional Patent Application No. 61/109,865 filed on Oct. 30, 2008, the entire contents of which is incorporated herein by reference.

### BACKGROUND

Dipper wells are widely used in coffee shops and restaurants to store and clean silverware and other smallwares, such as spoons, measuring cups, or ice-cream scoops. To rinse contaminants off the smallware and to fulfill health code standards, a constant water flow into the dipper well is required, which results in a high water usage. It is not uncommon that a single dipper well consumes up to 200 gallons of water per day.

### SUMMARY

Some embodiments of the invention provide a dipper well including a basin, an overflow, and a recirculation system. The basin can include an upper end and a bottom end. The overflow can be disposed adjacent to the upper end. The recirculation system can include an inflow, a pump, and an outflow. The inflow and the outflow can be in fluid communication with the basin. The inflow can be positioned upstream of the overflow. The pump can propel a fluid through the outflow in order to induce a positive flow velocity into the basin.

### DESCRIPTION OF THE DRAWINGS

FIG. 1 is a schematic cross-sectional view of a prior art dipper well.

FIG. 2 is a schematic cross-sectional view of a dipper well according to one embodiment of the invention.

FIG. 3 is a schematic cross-sectional view of a dipper well including an activation mechanism according to one embodiment of the invention.

FIG. 4 is a schematic cross-sectional view of a dipper well according to another embodiment of the invention.

FIG. 5 is a schematic cross-sectional view of a dipper well including a trough according to one embodiment of the invention.

FIG. 6 is a top view of the dipper well of FIG. 5.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

FIG. 1 illustrates a prior art dipper well 1. The dipper well 1 includes a basin 2. Water is generally constantly added to the top of the basin 2 through a water inlet 3. The basin 2 includes an overflow 4 to wash away a froth 5 that accumulates on the top surface of the water in the basin 2. The froth 5 includes contaminants 6 rinsed off from smallware 7 inserted into the basin 2. The contaminants 6 also include food particles from the smallware 7. The smallware 7 can include utensils, such as, for example, spoons, forks, knives, and cups. For cleaning purposes, a drain 8 is used to periodically empty the basin 2.

As shown in FIG. 1, the portion of the smallware 7 that is most contaminated is often the farthest away from the water inlet 3. Fresh water coming from the water inlet 3 is added to the top of the dipper well 1, whereas the contaminated portion of the smallware 7 is well under the water surface. Water being added from the water inlet 3 mixes with the froth 5 before flowing beneath the water surface and potentially carries contaminants in the froth 5 downward into the bulk liquid in the dipper well 1. As a result, the contaminated portion of the smallware 7 often receives little or no fresh water at a slow or near zero velocity. Also, contaminants 6 rinsed off the smallware 7 build up in the froth 5 on the top surface of the water in the basin 2 close to the overflow 4 so that the smallware 7 also comes into contact with the froth 5 when removed from the basin 2.

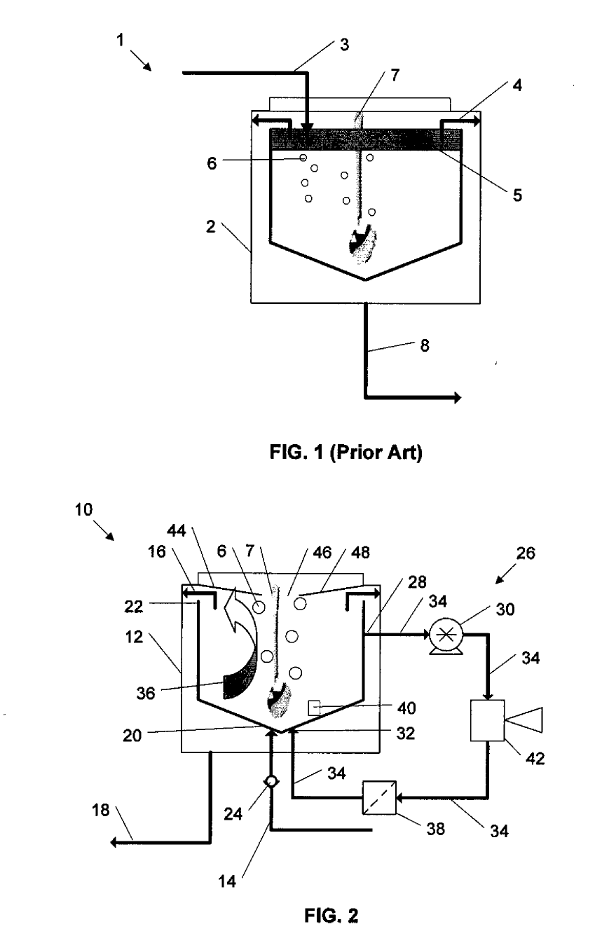

FIG. 2 illustrates a dipper well 10 according to one embodiment of the invention. The dipper well 10 can include a basin 12, a liquid inlet 14, an overflow 16, and a drain 18 (which can be normally open). The basin 12 can include a bottom end 20 and an upper end 22. In some embodiments, the liquid inlet 14 can be coupled to the bottom end 20 while, in other embodiments, the liquid inlet 14 can be positioned in accordance with existing plumbing and/or health codes. The liquid inlet 14 can include a back-flow prevention device, such as a check valve 24, to prevent a fluid from flowing back into the fresh water liquid inlet 14. In some embodiments, the liquid inlet 14 can induce a positive (i.e., upward) flow velocity in the basin 12. The basin 12 can be periodically emptied through the drain 18 for cleaning purposes. In some embodiments, the overflow 16 can be in fluid communication with the drain 18. In some embodiments, the basin 12 can include brushes (not shown) to help clean the inserted smallware 7.

In some embodiments, as shown in FIG. 2, the dipper well 10 can include a recirculation system 26. The recirculation system 26 can include an inflow 28, a pump 30, and an outflow 32. A conduit 34 can provide fluid communication between the inflow 28 and the outflow 32. The inflow 28 and the outflow 32 can be positioned at suitable locations on the basin 12. In some embodiments, the inflow 28 can be connected to the basin 12 adjacent to the upper end 22 and/or the overflow 16. In some embodiments, the outflow 32 can be coupled to the basin 12 adjacent to the bottom end 20 in order to induce a positive flow velocity into the basin 12 (as indicated by arrow 36). In some embodiments, the outflow 32 can be located adjacent to the liquid inlet 14. In some embodiments, a distance between the inflow 28 and the outflow 32 can help prevent the recirculation system 26 from drawing a fluid coming from the outflow 32 directly back through the inflow 28. The distance between the inflow 28 and the outflow 32 can help mix the fluid coming from the recirculation system 26 with a fluid in the basin 12 before possibly re-entering the recirculation system 26.

The pump 30 can draw a fluid from the basin 12 into the conduit 34 through the inflow 28. The pump 30 can be any one of a centrifugal pump, a rotary vane pump, a reversible positive displacement pump, and a diaphragm pump. The fluid can be routed back into the basin 12 through the outflow 32. In some embodiments, the fluid can flow through a filter 38 while passing through the recirculation system 26. The filter 38 can help reduce the contaminants 6 from the fluid. The filter 38 can include a suitable filter medium such as, for example, paper, cloth, mesh, and/or a bed of sorptive media to help remove dissolved contaminants from the re-circulated fluid. In some embodiments, the filter 38 can be positioned downstream of the pump 30 while, in other embodiments, the filter 38 can be positioned upstream of the pump 30.

The fluid coming from the recirculation system 26 can reenter the basin 12 through a nozzle (not shown). The nozzle can induce a certain flow pattern and/or direction of flow into the basin 12. In some embodiments, the conduit 34 can be arranged so that the fluid must flow past a flow direction control device 40. The flow direction control device 40 can induce a certain flow pattern and/or direction of the flow (as indicated by the arrow 36) to help rinse off the contaminants 6 from the smallware 7. In some embodiments, the fluid coming from the liquid inlet 14 can flow past the flow direction control device 40.

The contaminants 6 can be rinsed off the smallware 7 with the fluid coming from the liquid inlet 14. The contaminants 6 can also be rinsed off the smallware 7 with the fluid from the recirculation system 26. The contaminants 6 can exit the basin 12 through the overflow 16.

In some embodiments, the recirculation system 26 can include a gas injection system 42. The gas injection system 42 can help lift the contaminants 6 up from below the water level to the overflow 16. As a result, the flow rate through the liquid inlet 14 can be reduced. In some embodiments, the gas injection system 42 can include a venturi nozzle while, in other embodiments, the gas injection system 42 can include a separate device, such as a compressor, bottled gas, or a pressurized gas tank. In some embodiments, the gas injection system 42 can be positioned downstream of the pump 30 (as shown in FIG. 2). In some embodiments, the gas injection system 42 can be positioned downstream of the filter 38 while, in other embodiments, the filter 38 can be positioned downstream of the gas injection system 42.

The recirculation system 26 can reduce a backup of the froth 5 near the overflow 16 and/or the upper end 22. In some embodiments, the recirculation system 26 can reduce the flow rate through the liquid inlet 14 and/or the overflow 16. In some embodiments, the water consumption of the dipper well 10 can be reduced to only a few gallons of water per day, if not less.

In some embodiments, the dipper well 10 can include a lid or baffles 44. The lid 44 can help direct the contaminants 6 toward the overflow 16. The lid 44 can include a disc or a ring. In some embodiments, the lid 44 can include an opening 46 to enable the insertion of the smallware 7. In some embodiments, the lid 44 can include segments 48, which can deflect when the smallware 7 is inserted. In some embodiments, the lid 44 can be a slotted rubber diaphragm.

FIG. 3 illustrates a dipper well 100 including an activation mechanism 102 according to one embodiment of the invention. The activation mechanism 102 can include a sensor 104 and a controller 106. The sensor 104 can include an optical sensor or other suitable proximity sensors. The sensor 104 can detect when the smallware 7 is inserted in a basin 112 and can send a signal to the controller 106, which can activate a rinsing cycle to clean the smallware 7.

The dipper well 100 can include the basin 112, a liquid inlet 114, an overflow 116, and a drain 118. The basin 112 can include a bottom end 120 and an upper end 122. The liquid inlet 114 can be positioned adjacent to the upper end 122 according to federal, state, and/or local codes. The overflow 116 can be in fluid communication with the drain 118, which can be normally open.

In some embodiments, the dipper well 100 can include a recirculation system 124. The recirculation system 124 can include an inflow 126, a pump 128, a filter 130, and an outflow 132. A conduit 134 can provide fluid communication between the inflow 126 and the outflow 132. The inflow 126 and the outflow 132 can be in fluid communication with the basin 112. In some embodiments, the inflow 126 can be near the upper end 122 and/or the overflow 116. In some embodiments, the outflow 132 can be positioned adjacent to the bottom end 120. As indicated by arrow 136, the outflow 132 can induce a positive flow velocity into the basin 112.

In some embodiments, the basin 112 can include a flow direction control device 138. In some embodiments, the positive flow velocity induced by the outflow 132 and/or the flow direction control device 138 can help the contaminants 6 be rinsed off the smallware 7. The flow direction control device 138 can include ribs, baffles, discs, flaps, and other suitable structures capable of inducing a certain flow pattern. As shown in FIG. 3, the flow direction control device 138 can include a flap, which can direct the fluid coming from the outflow 132 in a specific direction toward the smallware 7. In some embodiments, a peripheral shape of the flow direction control device 138 can be similar to a peripheral shape of the basin 112.

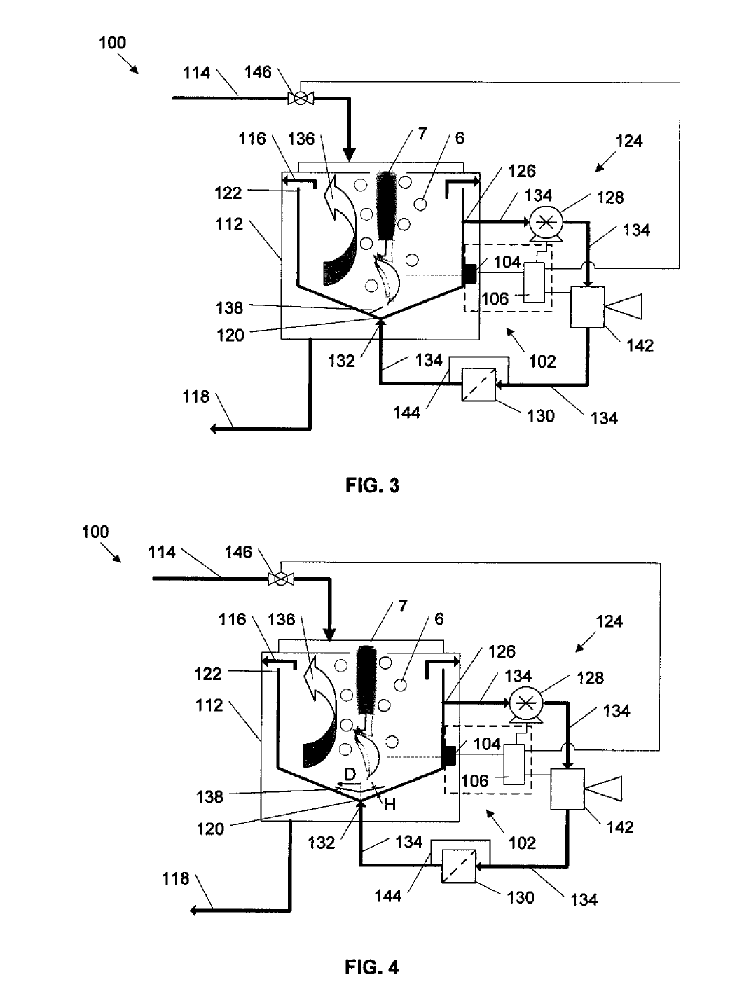

In some embodiments, the flow direction control device 138 can increase a flow velocity and/or generate a jet to enhance the removal of the contaminants 6 from the smallware 7 and/or help the contaminants 6 reach the overflow 116. As shown in FIG. 4, a height H between the flow direction control device 138 and the basin 112 can vary over the length of the flow direction control device 138. In some embodiments, the height H can decrease with an increasing distance D away from the outflow 132.

As shown in FIGS. 3 and 4, in some embodiments, the recirculation system 124 can include a gas injection system 142. The gas injection system 142 can help clean the smallware 7 and/or can help reduce the water consumption of the dipper well 100. In some embodiments, the gas injection system 142 can help lift the contaminants 6 washed off the smallware 7 up to the overflow 116. In some embodiments, the gas injection system 142 can help reduce the contaminants 6 that enter the recirculation system 124. In some embodiments, the gas injection system 124 can be positioned upstream of the filter 130, which can help remove the contaminants 6 from the fluid passing through the recirculation system 124.

In some embodiments, as shown in FIGS. 3 and 4, the filter 130 can include a ventilation passage 144 that can bypass the filter 130. The ventilation passage 144 can enable the injected gas to flow through the ventilation passage 144 but not the fluid. The ventilation passage 144 can include a gas permeable membrane. In some embodiments, the injected gas can help remove the contaminants 6 from the filter 130. The ventilation passage 144 can help ensure a uniform wetting of the filter 130. As a result, the gas injection system 142 can prolong the lifespan of the filter 130.

In some embodiments, the activation mechanism 102 can operate the pump 128 and/or the gas injection system 142. When the smallware 7 is inserted into the basin 112, the sensor 104 can send a signal to the controller 106, which can activate the pump 128 in order to initiate the rinsing cycle. The pump 128 can draw the fluid from the basin 112 and can propel the fluid through the filter 130 toward the outflow 132. In some embodiments, the gas injection system 142 can be selectively operated by the controller 106. In some embodiments including the venturi nozzle, the gas injection system 142 can include a check valve on a gas line of the venturi nozzle in order to prevent the fluid from leaking into the gas line when the pump 128 is not running.

In some embodiments, the controller 106 can adjust a flow rate through the recirculation system 124 according to the amount of smallware 7 detected by the sensor 104. For example, if the sensor 104 detects the insertion of the smallware 7, the controller 106 can operate the pump 128 at a first speed. If additional smallware 7 is inserted, the controller 106 can increase the speed of the pump 128. In some embodiments, the controller 106 can include a timer, which can enable the rinsing cycle to run for a certain time period. In some embodiments, if no smallware 7 is inserted in the basin 112 for the certain time period, the controller 106 can shut-down the recirculation system 124 to conserve energy and water. In some embodiments, the activation mechanism 102 can operate the liquid inlet 114 and/or adjust the flow rate through the liquid inlet 114. In some embodiments, as shown in FIGS. 3 and 4, the controller 106 can adjust the flow rate through the liquid inlet 114 using a valve 146. In some embodiments, the controller 106 can store the number of activations of the rinsing cycle. In some embodiments, the number of activations of the rinsing cycle and/or the amount of smallware 7 can determine the flow rate through the liquid inlet 114.

In some embodiments, the controller 106 can include a flushing cycle. The controller 106 can operate the pump 128 in reverse in order to draw the fluid into the recirculation system 124 through the outflow 132. The fluid coming from the outflow 132 can be used to flush contaminants of the filter 130. The fluid can wash the contaminants from the filter 130 through the inflow 126 toward the overflow 116. In some embodiments, the controller 106 can initiate the flushing cycle periodically.

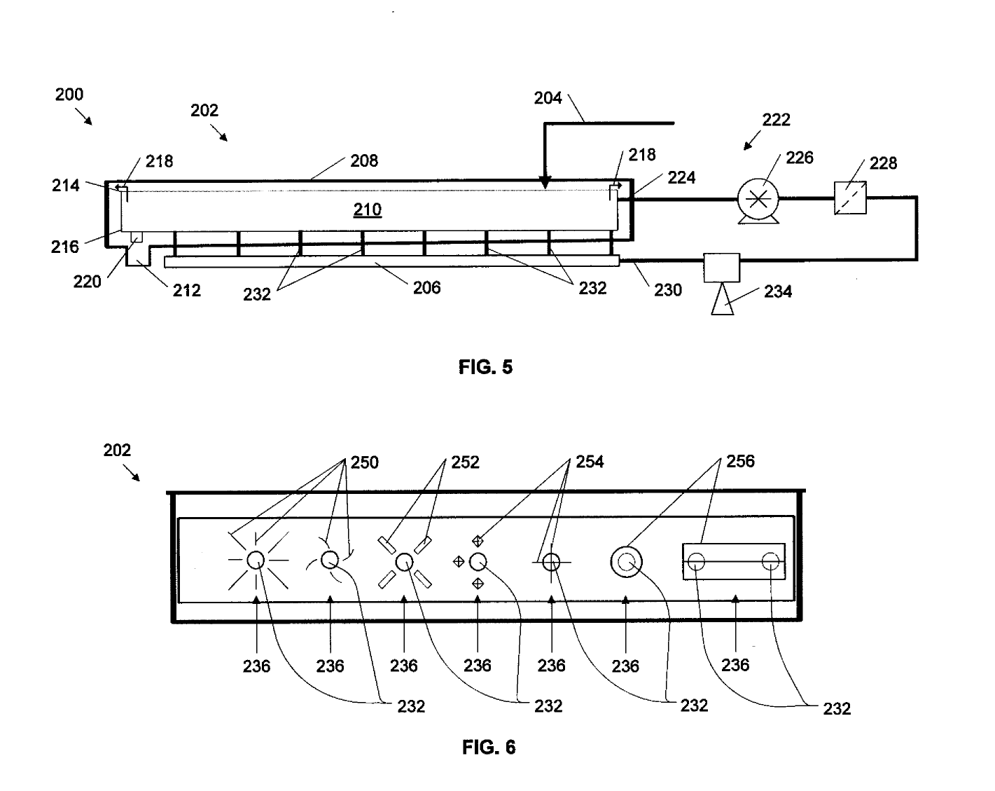

FIG. 5 illustrates a dipper well 200 according to another embodiment of the invention. The dipper well 200 can include an elongated basin or trough 202, a liquid inlet 204, and a manifold 206. The elongated basin 202 can include an outer container 208 and an inner container 210. The outer container 208 can include a drain 212. The inner container 210 can include an upper end 214 and a bottom end 216. The inner container 210 can include an overflow 218 and an outlet 220. The overflow 218 can provide fluid communication between the inner container 210 and the outer container 208. The outlet 220 can be normally closed and can be opened to periodically drain the fluid from the inner container 210. The drain 212 can be normally open to drain fluids coming from the overflow 218 and/or the outlet 220. In some embodiments, the basin 202 can be mounted along a counter in a restaurant.

In some embodiments, the dipper well 200 can include a recirculation system 222. The recirculation system 222 can include an inflow 224, a pump 226, a filter 228, and an outflow 230. The inflow 224 can be in fluid communication with the inner container 210. In some embodiments, the inflow 224 can be located near the upper end 214. The pump 226 can draw fluid from the inner container 210 and can pump the fluid through the filter 228. The filter 228 can help reduce contaminants within the fluid. The pump 226 can propel the fluid through the outflow 230, which can be in fluid communication with the manifold 206. The manifold 206 can include at least one flow passage 232, which can provide fluid communication with the inner container 210. In some embodiments, the at least one flow passage 232 can be coupled to the bottom end 216 of the inner container 210. In some embodiments, the manifold 206 can divide the fluid coming from the recirculation system 222 into the at least one flow passage 232 in order to recirculate the fluid along the length of the inner container 210.

In some embodiments, the recirculation system 222 can include a gas injection system 234. The gas injection system 234 can be positioned between the filter 228 and the outflow 230. In some embodiments, the gas injection system 234 can use dissolved air floatation to capture the contaminants within the fluid. The gas injections system 234 can create bubbles within the flow passage 232. The bubbles can adhere to the contaminants. Injected gas can help the contaminants to cascade over the overflow 218. In some embodiments, the gas injection system 234 can help reduce the backup of the froth 5 at the upper end 214 of the inner container 210.

FIG. 6 illustrates a variety of flow direction control devices 236 according to some embodiments of the invention for use in the basin 202. The flow direction control devices 236 can be coupled to the inner container 210. In some embodiments, the flow direction control devices 236 can be coupled to the bottom end 216 while, in other embodiments, the flow direction control devices 236 can be coupled to a sidewall of the inner container 210. In some embodiments, the flow direction control devices 236 can be positioned around the flow passage 232 in a regular pattern while, in other embodiments, the flow direction control devices 236 can be positioned irregularly.

In some embodiments, the flow direction control devices 236 can include ribs 250, which can be positioned around the flow passage 232. In some embodiments, the ribs 250 can be curved. The ribs 250 can induce a swirl into the basin 202. In other embodiments, the flow direction control devices 236 can include flaps 252, which can induce a positive flow velocity. In some embodiments, the flaps 252 can be curved upwardly.

In some embodiments, the flow direction control devices 236 can include a vortex generator 254. In some embodiments, the vortex generator 254 can extend over the flow passage 232 while, in other embodiments, the vortex generator 254 can be positioned adjacent to the flow passage 232. In some embodiments, the vortex generator 254 can include roughness elements, which can take a suitable shape (e.g., spherical, cylindrical, triangular, rectangular, diamond-shaped, etc.).

In some embodiments, the flow direction control devices 236 can include a deflector 256. The deflector 256 can be positioned downstream from the flow passage 232. The deflector 256 can help change a direction of the fluid coming from the flow passage 232. The deflector 256 can create a jet to help clean the smallware 7. In some embodiments, the shape of the deflector 256 can complement the shape of the basin 202 and/or the shape of the flow passage 232.

The flow direction control devices 236 can help remove contaminants. In some embodiments, the flow direction control devices 236 can induce a positive flow velocity and/or a swirl into the basin 202. In other embodiments, the flow direction control devices 236 can increase a turbulence level within the basin 202. The flow direction control devices 236 of some embodiments can create a jet to rinse off the contaminants.

In some embodiments, the smallware can include ice-cream scoops, which can be cleaned in the dipper well 200. Typically, ice-cream shops sell a variety of different types of ice-cream (e.g., milk products, soy, and sorbets), as well as a variety of different flavors (e.g., flavors including peanuts and other nuts). Some customers might be allergic to peanuts or other nuts in some flavors of the ice cream. In some embodiments, the dipper well 200 can help reduce cross-contamination of allergens by effectively rinsing contaminants off the smallware. In some embodiments, the recirculation system 222 can reduce the flow rate through the liquid inlet 204, while maintaining the effectiveness of the dipper well 200.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A dipper well for use in cleaning contaminants from smallware with a fluid, the dipper well comprising:
a basin including an upper end and a bottom end;
an overflow adjacent to the upper end; and
a recirculation system including an inflow, a pump, and an outflow, the inflow and the outflow being in fluid communication with the basin, the inflow positioned upstream from the overflow, the pump propelling the fluid through the outflow in order to induce a positive flow velocity into the basin.

2. The dipper well of claim 1, wherein the basin is an elongated trough.

3. The dipper well of claim 1, and further comprising a liquid inlet.

4. The dipper well of claim 3, wherein at least one of the liquid inlet and the outflow is positioned adjacent to the bottom end of the basin.

5. The dipper well of claim 1, wherein the recirculation system includes a filter.

6. The dipper well of claim 5, wherein the filter is positioned downstream from the pump.

7. The dipper well of claim 1, wherein the recirculation system includes a gas injection system positioned downstream from the pump.

8. The dipper well of claim 7, wherein the gas injection system is included with the pump.

9. The dipper well of claim 8, wherein the gas injection system includes a venturi nozzle.

10. The dipper well of claim 1, wherein the recirculation system includes a filter and a gas injection system.

11. The dipper well of claim 10, wherein the gas injection system is positioned downstream from the filter.

12. The dipper well of claim 10, wherein the filter includes a ventilation passage to enable a gas injected by the gas injection system to bypass the filter.

13. The dipper well of claim 1, wherein the recirculation system reduces a backup of froth near the overflow.

14. The dipper well of claim 1, and further comprising a drain in fluid communication with the overflow.

15. The dipper well of claim 1, and further comprising at least one flow direction control device.

16. The dipper well of claim 15, wherein the flow direction control device is positioned on the bottom end of the basin.

17. The dipper well of claim 15, wherein the flow direction control device is positioned adjacent to the outflow.

18. The dipper well of claim 1, and further comprising an activation mechanism that is operated when smallware is inserted in the basin.

19. The dipper well of claim 18, wherein the activation mechanism is capable of operating the pump.

20. The dipper well of claim 18, wherein the activation mechanism includes a proximity sensor.
